(19) United States
(12) Patent Application Publication
(10) Pub. No.: US 2009/0145740 A1
(43) Pub. Date: Jun. 11, 2009

(54) Method for Expansion and Molding of Polymeric Foam

(76) Inventors: Indraneel Sen, Knoxville, TN (US); Dayakar Penumadu, Knoxville, TN (US); Roberto Benson, Knoxville, TN (US)

Correspondence Address: WADDEY & PATTERSON, P.C., 1600 DIVISION STREET, SUITE 500, NASHVILLE, TN, 37203, US

(21) Appl. No.: 12/246,249

(22) Filed: Oct. 6, 2008

Related U.S. Application Data
(60) Provisional application No. 60/977,390, filed on Oct. 4, 2007.

(51) Int. Cl. C08J 9/228

(52) U.S. Cl. 204/157.6

(57) ABSTRACT

A method for creating a foam product using microwaves and alcohol useful for various industrial applications. The method of creating polymeric foam includes 2-butanol used in conjunction with microwaves to create a polymer foam material.

### CROSS-REFERENCES TO RELATED APPLICATIONS

This application is a utility application which claims benefit of Provisional Patent Application Serial No. 60/977,390 filed October 4, 2007, entitled “Method for Expansion and Molding of Polymeric Foam” which is hereby incorporated by reference.

### BACKGROUND OF THE INVENTION

### TECHNICAL FIELD

The present invention relates to a novel method of creating a polymeric foam useful for a variety of industrial applications. More particularly, the present invention relates to a method of creating polymeric foam through the use of alcohols, including 2-butanol used in conjunction with microwaves to create a polymer foam material.

Generally, foams are created from spherical, expandable polystyrene beads formed from a liquid monomer suspended in an aqueous medium, containing an expansion agent. In foaming the monomeric or polymeric substance, expansion aids are utilized including such common expansion agents as pentane isomers which are liberated into the atmosphere during the production of the foams. These agents are often categorized as green house gases and volatile organic compounds (VOCs) that have been shown to contribute to both smog and at least partially to the generation of lower stratospheric ozone. Pentane emissions from expanded polystyrene (EPS) producing plants are generally uncontrolled.

A major disadvantage of pentane isomers is their low flash point and high evaporation rate. As known in the art, pentane isomers are five carbon saturated hydrocarbons and are excellent fuels with heat of combustion of approximately 48.8 kJ/gm for n-pentane. As pentane forms explosive mixtures with air, precautions must be taken whenever pentane is used. Often, practices necessitate a lag time to allow fumes or vapors to dissipate. Furthermore, care must be taken to prevent static electricity and sparks from possibly igniting any pentane vapors.

Pentane is often emitted from the EPS foam production in about three different ways including: (1) manufacturing emissions, (2) foam cell losses occurring during both storage and shipping and also (3) banked emissions, which result as losses that occur through slow diffusion of the blowing agent out of the foam over the life of the foam product.

Previously, a variety of different methods have been utilized for the manufacturing of shaped polystyrene bodies including U.S. Pat. No. 3,042,973 issued to Brockhous et al. which discloses the formation of shaped polystyrene foam bodies through the use of steam having a temperature of about 110° C. to about 115° C.

In Landon (U.S. Pat. No. 3,446,882) polystyrene structures are allegedly formed within a container where polystyrene beads are expanded by contact with a stream of hot air so that the latent heat therefore is sufficient to fuse the beads, thus eliminating the need for applying heat to the container to cause fusion of the expanded beads.

In U.S. Pat. No. 4,303,756 issued to Kajimura et al., a process is described for producing expandable thermoplastic resin beads. In the '756 patent, improved expandable thermoplastic resin particles are allegedly obtained by graft polymerizing a vinyl aromatic monomer in the presence of a polymerization catalyst onto a backbone of a random copolymer of propylene and ethylene as a nucleus and impregnating the resulting thermoplastic resin beads with a blowing agent. The '756 patent describes the use of easily volatilizable blowing agents for use with this invention.

Nazar et al., U.S. Pat. No. 4,765,934, describes polyester beads or beads of other thermoplastic materials expanded to a consolidated foam structure by providing the beads with a uniform coating of a saturated brine solution including water or other aqueous solution of water soluble salt and exposing the solution to microwave energy to boil the solution and thereby heat the beads to cause expansion and fusion to a foam structure. More particularly, the '934 patent alleges the utilization of microwave energy and water heated by such microwave energy to create rapid and effective expansion of the beads to a foam structure. A disadvantage of using water as an expansion agent as disclosed in the '934 patent is that water is completely insoluble in styrene and polystyrene and thus has to be mechanically dispersed throughout the polymer matrix. This may result in an inhomogeneous dispersion causing a wide variation in phase size, concentration and distribution finally resulting in non-uniformity of cell structure in the final foam product.

Harclerode et al. (U.S. Pat. No. 5,114,640) describes a method for making low density expanded polymeric products using blowing agents in an amount of any from 2 to about 4.4 weigh percent. Generally, the blowing agents are discussed as a wide variety which could be utilized in the invention including a preferable group comprising pentane, cyclopentane, and neopentane, among other hydrocarbons.

York, in U.S. Pat. No. 5,147,896 provides for a blown agent composition method for producing the polymeric foam and particularly styrenic and ethylenic foam. More specifically, the '896 patent utilizes at least one polyfluorcarbon blowing agent as such blowing agents which allegedly provides for less ozone depletion and are not substantially photochemically reactive.

In coming years, the polymer industry will likely be forced by new regulations to drastically reduce the level of VOC emissions generated during the production of foams.

The current production of foam often uses steam as an energy source for expansion of solid polystyrene beads which usually requires extensive machinery for the steam generation and transmission which in turn requires extensive floor and ceiling space. As such, it is a common industrial practice to reduce components in the process chain through industrial engineering design since lesser components decrease maintenance costs, probability of process shutdown due to component failure and probability of product rejection. due to defect with FIG. 1 illustrating the general steps of steam generation and transmission as known in the prior art.

A list of gaseous emissions originating in the existing process of manufacturing of EPS foam is presented in Table 1 [Boustead, 1999].

TABLE 1
Gross gaseous emissions arising from the production of 1 kg
of EPS. [Boustead, 1999]

| Emission | Total in gm. |
|---|---|
| Dust | 1.8 |
| CO | 1.6 |
| CO₂ | 2,500 |
| SO_{X} | 9.7 |
| NO_{X} | 12 |
| *Hydrocarbons | 4.5 |
| *Methane | 9.5 |

*Byproducts from commercial expansion agents.

Protection of industry human resource and reduction of flammable emissions require expensive plant ventilation and gas collection systems.

What is desired therefore is a method of reducing the health hazards associated with production of EPS foams through the replacement of currently used harmful expansion agents. Unfortunately, many of the most profitable and industrial applicable methods of producing EPS foam do not make use of a chemical reagent that is benign, recyclable, as well as being susceptible to selective heating by appropriate electromagnetic radiation. In addition, method using water expansion agents are plagued by a variety of problems making the methods less suitable for today's industry.

Further desired is a method of producing EPS foam through use of a chemical agent which is benign, recyclable, and susceptible to selective heating by appropriate electromagnetic radiation. Heating through EM radiation is desirable as it provides for a fast (induction) volumetric heating in comparison with the slower diffusion heating (conductive) that takes place from the surface of the polymer bead to the core, in the current industrial process of polystyrene bead expansion. Indeed, a combination of characteristics including the development of a novel production process providing an environmentally friendly, economic and efficient production higher than contemplated in the prior art, have been found to be necessary for the improved production of EPS foam while maintaining stringent safety standards and reducing shop floor space.

### SUMMARY OF THE INVENTION

The present invention provides a method for creating the EPS foam which is uniquely capable of utilizing a benign expansion agent that can be heated by a microwave radiation. The inventive process also maximizes recovery and recycling of the novel expansion agent while providing a maximized efficiency with microradiation as the volumetric heating source. Furthermore, the novel process requires a minimized work shop space while reducing maintenance costs as fewer components are required in the process. Yet furthermore, expensive tooling is reduced as economic radiation transparent thermoset or glass molds may be utilized instead of the stainless steel molds often utilized in the prior art.

More particularly, the present invention makes use of specific expansion agents. In selecting appropriate expansion agents, many different organic solvents were considered as potential expansion agents for the present invention. Non-polar molecules such as aromatic hydrocarbons (e.g. Benzene, Toluene, Diethyl Ether) were not as useful as they are substantially incompatibility with microwave heating. Organic solvents such as aldehydes, ketones and halogenated hydrocarbons (e.g. Methyl Ethyl Ketone, Methylene Chloride and Chloroform) were also not selected for the present invention due to their toxicity, volatility and/or high flammability. Alcohols, the least toxic of organic solvents, were selected for the study based on their volatility, flammability, boiling point and commercial availability. Specifically, 2-butanol, 2-propanol and ethanol were identified as preferable expansion agents, though other agents may also be used with success with the present invention.

Advantageously, to produce foam by the method of the present invention, an alcohol, preferably 2-butanol, 2-propanol, and ethanol are provided with either a polymeric or monomeric matrix and subsequently heated by electromagnetic radiation which provides for the alcohol to expand the matrix. More preferably, 2-butanol is heated above its boiling point through the use of microwave energy to form a foam product from the polymeric matrix substrate.

The object of the invention, therefore, is a process of producing a foam product utilizing a benign expansion agent which is more environmentally sound.

Another object of the invention is a method for producing foam including the use of microwave radiation.

Still another object of the invention is a method for producing foam wherein recovering and recycling of the expansion agent may be maximized.

Yet another object of the invention is a method for producing foam which substantially maximizes the efficiency with microwave radiation as a volumetric heating source while minimizing the work shop space required for the necessary equipment.

Another object of the present invention is a method of producing foam requiring a minimized maintenance cost through the utilization of lesser components.

Still another object of the invention is a method of producing a molded foam product through the use of radiation transparent thermoset or glass molds.

These aspects and others that will become apparent to the artisan upon review of the following description can be accomplished through the method of providing an alcohol as a blowing or expansion agent with a polymeric or monomeric substrate matrix and exposing the combination to radiation. The inventive method of producing foam advantageously utilizes alcohols which are known as the least toxic of organic substances while providing a more economical method of creating the foam product.

It is to be understood that both the foregoing general description and the following detailed description provide embodiments of the invention and are intended to provide an overview of framework of understanding to nature and character of the invention as it is claimed.

### BRIEF DESCRIPTION OF THE DRAWINGS

FIG. 1 is a schematic illustration showing the current process of steam generation and transmission as a multistep process.

FIG. 2 is an illustration showing the expansion of a polymer bead using the method of the present application.

FIG. 3 is a schematic illustration of a plot of a solubility sphere in a 3-D Hansen plot.

FIG. 4 illustrates three different plots that show the dipole polarization effect on water where the water dipole movement is aligned to the field and rotates in order to follow the field.

FIG. 5 illustrates three plots of the ionic conduction affect on a chlorine ion where the negatively charged chlorine ion is attracted to the positive portion of the microwave and repelled by the negative section of the microwave.

FIG. 6 is a photograph of a precision furnace which may be used for the polymerization and determination of phase diagram experiments.

FIG. 7 is an illustration of the dimensions of a reaction vial in comparison to the dimensions of a pellet which may be used in experimentation in comparison to a typical polystyrene commercial bead of an approximate 300 micrometer size.

FIG. 8a is a SEM image for visualization of the 2-butanol phase separation.

FIG. 8b is a processed binary image of the 2-butanol phase separation to determine the mean diameter standard deviation and size distribution.

FIG. 9 is a photograph of a possible laboratory scale microwave oven which may be used to expand polystyrene pellets of different 2-butanol concentrations.

FIG. 10a is a photograph of an 8% concentration of 2-butanol in a polystyrene matrix as a cylindrical pellet.

FIG. 10b is an illustration of a 7% concentration of 2-butanol in a polystyrene matrix as a cylindrical pellet.

FIG. 10c is an illustration of a 6% concentration of 2-butanol in a polystyrene matrix as a cylindrical pellet.

FIG. 11a is an illustration of thermogravimetric analysis results showing the weight loss of a 2-butanol sample containing 12% by volume.

FIG. 11b is an illustration of thermogravimetric analysis results showing the weight loss of a 2-butanol sample containing 16% by volume.

FIG. 11c is an illustration of thermogravimetric analysis results showing the weight loss of a 2-butanol sample containing 18% by volume.

FIG. 12 illustrates DSC results for expandable polystyrene with various concentrations of 2-butanol.

FIG. 13 is an illustration of the time temperature program where the temperature is modulated in the range from about 25° C. to about 75° C. over a period of about 50 seconds.

FIG. 14 is an illustration of the modulated DSC results where the temperature was controlled for the ranges of about 25° C. to about 75° C.

FIG. 15a illustrates a SEM image showing polymerization-induced phase separation of a 6% by volume concentration of 2-butanol in polystyrene.

FIG. 15b illustrates a SEM image showing polymerization-induced phase separation of an 8% by volume concentration of 2-butanol in polystyrene.

FIG. 15c illustrates a SEM image showing polymerization-induced phase separation of a 10% by volume concentration of 2-butanol in polystyrene.

FIG. 16a illustrates a SEM image showing polymerization-induced phase separation of a 12% by volume concentration of 2-butanol in polystyrene.

FIG. 16b illustrates a SEM image showing polymerization-induced phase separation of a 14% by volume concentration of 2-butanol in polystyrene.

FIG. 16c illustrates a SEM image showing polymerization-induced phase separation of a 16% by volume concentration of 2-butanol in polystyrene.

FIG. 17 illustrates a plot of the phase diagram (cloud point) for 2-butanol in a polystyrene matrix.

FIG. 18a illustrates a polystyrene pellet in a glass tube mold.

FIG. 18b illustrates a polystyrene pellet expanded into foam taking the shape of a glass mold.

FIG. 19a is a photograph of three expandable pellets of polystyrene and 2-butanol with the first pellet having an 8% volumetric concentration of 2-butanol, the second pellet having a 7% volumetric concentration of 2-butanol and the third having a 6% volumetric concentration of 2-butanol.

FIG. 19b is a photograph of three polystyrene and 2-butanol pellets expanded into foam with the first having an 8% volumetric concentration of 2-butanol, the second having a 7% volumetric concentration of 2-butanol and the third having a 6% volumetric concentration of 2-butanol.

FIG. 20a is a photograph of a polystyrene pellet having a 4% 2-butanol concentration prior to microwaving.

FIG. 20b is a photograph the polystyrene pellet of FIG. 20a after being subjected to microwaves.

FIG. 20c is an illustration of a polystyrene pellet after microwaving having an initial 6% 2-butanol concentration.

FIG. 20d is a photograph of a side view of a polystyrene pellet after microwaving having an initial 6% 2-butanol concentration.

FIG. 20e is a photograph of the top surface of a polystyrene foam having an initial 8% 2-butanol concentration.

FIG. 20f is a photograph of the interior of a polystyrene foam having an initial 8% 2-butanol concentration.

FIG. 21 illustrates microwave expansion by dipole rotation on the top contrasted to microwave expansion by ionic conduction and dipole rotation through the use of lithium perchlorinate on the bottom.

FIG. 22 compares the energy requirement for expansion of polystyrene without ionic salts on the top two energy expansion with ionic salts on the bottom.

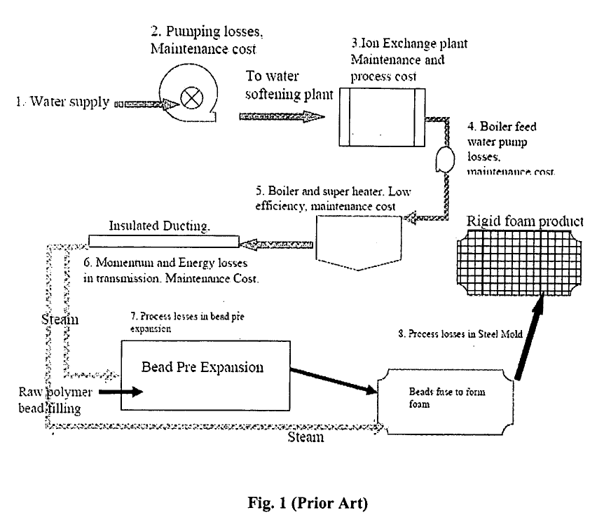

### DETAILED DESCRIPTION OF THE PREFERRED EMBODIMENTS

The method of forming foam in accordance with the present invention includes the use of an alcohol as the expansion agent for the foaming process. Preferably, 2-butanol, 2-propanol, and/or ethanol may be utilized as the most appropriate expansion agents.

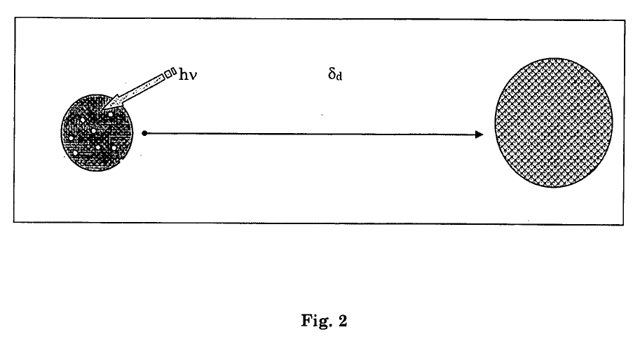

2-butanol boils at about 99° C., which is close to the glass transition temperature of one of the potential polymer substrates, polystyrene, which is approximately 100° C. This temperature correlation provides for the necessary expansion which can be achieved by using selective heating by electromagnetic radiation (EM). The 2-butanol phases volumetrically absorb EM radiation and heat the polymer matrix through conduction. As the liquid 2-butanol changes phase to gas above its boiling point, the polymer matrix may simultaneously reaches the glass transition and becomes rubbery, allowing the gaseous phase to expand the matrix as under a pressure differential as illustrated in FIG. 2. More specifically, 2-butanol absorbs radiation and the polymer matrix via the conduction from the 2-butanol and the sold beads expand to form an expanded foam bead.

2-butanol is an alcohol with a dipole moment of 1.8 Debye (water 1.8546 Debye) [CRC Handbook, 2006-07] and is susceptible to microwave heating. Generally, alcohols also have a very distinct infrared absorption band for wave numbers in the range of 3200 cm⁻¹ and 3600 cm⁻¹. As such, selective heating by IR sources in addition to microwave is also a possibility.

Furthermore, 2-butanol is substantially soluble in a styrene monomer and at least partially insoluble in polystyrene above a critical saturation concentration. This insolubility may be used to achieve polymerization induced phase separation (PIPS). The phase separation may produce morphology with an even distribution of the spherical alcohol phase (droplets) within the polymer matrix.

Unlike pentane isomers which are often utilized in the prior art as the expansion agent, 2-butanol is substantially nonvolatile, substantially nonflammable and substantially nontoxic while being an organic alcohol (Table 2) In addition 2-butanol may be recovered and recycled by using a room temperature trap. The use of 2-butanol as expansion agent, may provide for an economical and environmentally friendly process involving recycling of the expansion agent. In addition, economic benefits may be realized due to a potential relaxation of the rigorous flammable safety standards, currently practiced in the EPS foam industry.

The molar mass of 2-butanol, being approximately 74.12 is very close to the molar mass of pentane which is approximately 72.15. The higher boiling point and lower volatility of 2-butanol is due to the hydrogen bonding present as a result of the hydroxyl group present within 2-butanol. The high molar mass may account for the slower expulsion of 2-butanol from PS matrix as compared to water in water-expandable polystyrene (WEPS).

TABLE 2
Relevant physical properties of 2-butanol compared to n-pentane
[CRC Handbook]

| Name | 2-butanol | n-pentane |
|---|---|---|
| Molecular | C₄H₁₀O | C₅H₈ |
| Formula | | |
| Molecular weight gm/mol | 74.12 | 72.15 |
| Boiling Point | 99° C. | 36° C. |
| Specific gravity | 0.808 | 0.626 |
| Flash point | 26° C. | −50° C. |
| Explosion limits | 1.7%-9.8% | 1.4%-8.3% |
| Auto ignition temperature | 405° C. | 260° C. |
| Evaporation rate | 0.67 | 28.6 |
| Butyl acetate = 1 | | |
| Vapor pressure at 99° C. in mm Hg | 797 | 882 |
| Loss Tangent at 2.45 GHz | 0.447 | 0 |

Furthermore, in better describing the novel process of the present invention, discussion of the general chemistry is helpful. First, regarding polymerizations, when a polymerization reaction is carried out from a monomer, in the presence of a miscible oligomer, a soluble polymer or a small molecule like a solvent, a phase separation process usually may occur as the polymerization proceeds. This may lead to phase separated morphologies and distribution of the separated phases depending strongly on the initial composition and reaction kinetics.

Polymerization-induced phase separation (PIPS) may be used in practice to synthesize useful materials such as high-impact polystyrene (HIPS), rubber-modified thermosets, thermoplastic-thermoset blends, polymer-dispersed liquid crystals, thermally reversible light scattering films and nanostructured thermosets among other articles.

In the process of the present invention, a PIPS technique may be used in order to chemically achieve a uniform distribution of separated phases of 2-butanol in a matrix such as a polystyrene matrix instead of mechanical dispersion as in the process of producing water-expandable polystyrene (WEPS). In case of WEPS, water is completely insoluble in styrene monomer. The first step in the WEPS process was [Crevecoeur, 1999] bulk polymerization where a surfactant was added to disperse water droplets in partially polymerized styrene thus yielding a stable emulsion. Partial polymerization was carried out to increase the viscosity of the liquid media sufficient enough to stabilize the emulsion. In the second step this emulsion was suspended in water in the presence of a suitable suspension stabilizer and standard suspension polymerization was carried out in order to obtain beads.

Solubility and thus phase separation may be expressed in terms of the Hildebrand parameter denoted by δ [Hildebrand, 1916]. Practically it is possible to use this parameter without a thorough understanding of the molecular dynamics (MD) on which it is based. Hansen [1967] divided the total Hildebrand parameter value into three additive parts: a dispersion force component, hydrogen bonding component, and a polar component given by equation 1.

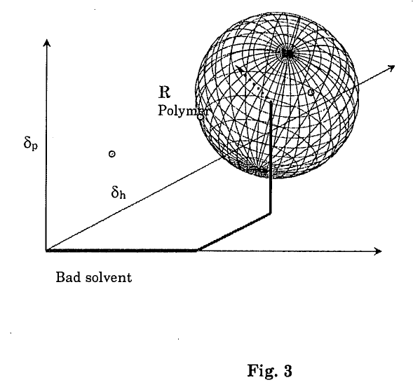

δₜ²=δ_{d}²+δₚ²+δₕ² (1)

where
δₜ=Total Hildebrand parameter
δ_{d}=dispersion component
δₚ=polar component
δₕ=hydrogen bonding component
   The Hildebrand parameter for each solvent at 25° C. can be plotted in a 3-D space by using the individual Hansen parameters as coordinates. For a polymer, a solubility sphere can be geometrically constructed in this 3-D space as seen in FIG. 3. The coordinates at the center of the solubility sphere are designated by means of three component parameters (δ_{d}, δₚ, δₕ) of the polymer, and the radius of the sphere, called the interaction radius (R). A polymer has a high probability to be soluble in a solvent at 25° C., if the Hansen parameters for the solvent lie within the solubility sphere for the polymer. In order to determine this (without rigorous simulations) the distance of the solvent point from the center of the polymer solubility sphere (D(S−P)) needs to be evaluated and should be less than the interaction radius for the polymer. Values of R for different polymers have been experimentally determined by trial with many different solvents and reported in literature. Gharagheizi et al. [2006] used intrinsic viscosities of the polymer in different solvents and the molar volumes of the solvents to develop a correlation between Hansen parameters and the polymer interaction radius. The radius of interaction for polystyrene is reported to be R=12.7 MPa^{1/2}

D_{(S-P)}=[4(δ_{d}s−δ_{d}p)²+(δₚS−δₚP)²+(δₕs−δₕp)² ]^{1/2} (2)

where
D_{(S-P)}=Distance between solvent and center of polymer solubility sphere
δₓs=Hansen component parameter for solvent
δₓp=Hansen component parameter for polymer

TABLE 3
Hansen parameters of monomer, polymer and expansion agents
at 25° C. [Krevelen, 1980]

| Species | δt (MPa^{1/2}) | δd(MPa^{1/2}) | δp(MPa^{1/2}) | δh(MPa^{1/2}) |
|---|---|---|---|---|
| n-pentane | 14.5 | 14.5 | 0 | 0 |
| 2-butanol | 22.2 | 15.8 | 5.7 | 14.5 |
| Styrene | 19 | 18.6 | 1 | 4.1 |
| Polystyrene | 18.6 | 21.3 | 5.8 | 4.3 |

Equation 2 may be used to calculate the distance between 2-butanol and polystyrene (PS) with Hansen values provide in Table 3. Based on the value of D_{(2-butanol-} PS) equaling approximately 17.96 which is greater than R=12.70, PS is expected to be completely insoluble in 2-butanol and a complete phase separation of the expansion agent in polystyrene matrix is expected at about 25° C.

An additional advantage of the present invention is realized over the prior art in that in the prior art commercial process, the n-pentane used as an expansion agent intercalates inside polystyrene beads by the process of diffusion while the alcohol, and preferably 2-butanol, may disperse in the laboratory experiment as separated phases by PIPS technique.

Thermodynamic analysis of PIPS illustrates that a major contribution for phase separation may be due to the change in the Flory-Huggins interaction parameter χ₁₂ resulting from associated changes in the chemical structure produced by polymerization [Chan, 1996]. Flory-Huggins theory [Flory, 1953] predicts an equilibrium phase diagram for a particular polymer and solvent system. In the present invention, the solvent may also be the expansion agent.

The thermodynamic phase diagram of polymer solution exhibiting a critical solution temperature is given by Equation 3, the Flory-Huggins free energy of mixing:

$$Δ F = \frac{{ϕ}_{1}}{n} ln {ϕ}_{1} + {ϕ}_{2} ln {ϕ}_{2} + {χ}_{12} {ϕ}_{1} {ϕ}_{2} \qquad ( 3 )$$

where, n is the statistical polymer segment length, ^{φ}^{₁} and ^{φ}^{₂} are the volume fractions of polymer and the solvent (expansion agent in this study) respectively And χ₁₂ is the Flory-Huggins interaction parameter between the polymer and the solvent.

$$\begin{matrix}{χ}_{12} = A + ( {χ}_{c} - A ) {T}_{c} / T & ( 4 ) \\ χ = 0.34 + \frac{{V}_{i}}{RT} {( {δ}_{i} - {δ}_{j} )}^{2} & ( 5 )\end{matrix}$$

A is the entropy correction factor, T the absolute temperature, Tc is the critical temperature and ^{χis c} is the critical interaction parameter given by

$${χ}_{c} = 0.5 {( 1 + \frac{1}{\sqrt{n}} )}^{2} \qquad ( 6 )$$

Bernardo [2007] where the interaction parameter (χ₁₂) may be experimentally determined for a series of alcohols and polystyrene system (Table 4). The value of the interaction parameter (χ₁₂) for 2-butanol-PS system may be calculated using equation 5. The critical interaction parameter (χc) for PS of approximately 22,000 may be calculated to be around 0.521. Within the entire temperature range of about 65° C. to about 95° C., χ₁₂>χc. This result signifies in accordance with Hansen parameters that 2-butanol may be substantially a non-solvent for PS in the temperature range of 25° C. to 95° C.

TABLE 4
Interaction parameter (χ₁₂) for alcohols in PS at different
temperature [Bernardo, 2007]

| Alcohol | χ₁₂ at 65° C. | χ₁₂ at 75° C. | χ₁₂ at 95° C. |
|---|---|---|---|
| 1-propanol | 1.6502 | 1.5408 | 1.3066 |
| 2-propanol | 1.7470 | 1.5958 | |
| 1-butanol | 1.5356 | 1.4449 | 1.2039 |
| 2-butanol (calculated) | 1.63 | 1.49 | 1.2 |

Regarding the use of microwaves for the process of the present invention, provided is a discussion on microwaves and in what capacity they may be utilized in carrying out the process of the present invention. Microwaves are electromagnetic waves that typically have a frequency range of from 0.3 GHz (as there is no actual specified lower frequency limit) to about 300 GHz with corresponding wavelengths of from about 1 m to about 1 mm. Generally, microwave power may be optimized depending upon the load. Microwaves travel at or at about the velocity of light and are comprised of oscillating electric and magnetic fields. Microwaves are generally coherent and polarized in contrast to visible electromagnetic waves, obviously apart from lasers. They obey the laws of optics and may be transmitted, absorbed or reflected depending on the type of material.

Furthermore, the microwave heating process is fundamentally different from the heating process used in conventional ovens. With microwaves, heat is most often generated internally within the material as opposed to originating from external heating sources. The energy injected in the material is transferred through the material surface electromagnetically, and does not flow as heat flux, as in conventional heating. Thus, the heating rate is not a function of the thermal diffusivity of the material and surface temperature. As a result, the thermal gradients and flow of heat may be the reverse of those in materials heated by conventional means. Thus, it is possible by using microwave to heat both large and small complex shapes very rapidly and uniformly. As per Meridith [1998], “Heating times can often be reduced to less than 1% of that required using conventional techniques, with effective energy variation within the workload less than 10%”. As the absorption of microwave energy varies with composition and chemical structure it is also possible to have selective heating. Almost all domestic microwave ovens and commercially available microwave sources for chemical synthesis operate at 2.45 GHz corresponding to a wavelength of 12.25 cm in order to avoid interference with cellular phones and telecommunication frequencies. Energy of a microwave photon at a frequency of about 2.45 GHz is about 1.6 mille electron volts and is much lower than covalent bond energies or even hydrogen bonds which are generally of from about 0.04 eV to about 0.44 eV. Thus microwaves generally do not induce chemical reactions by direct absorption of electromagnetic energy.

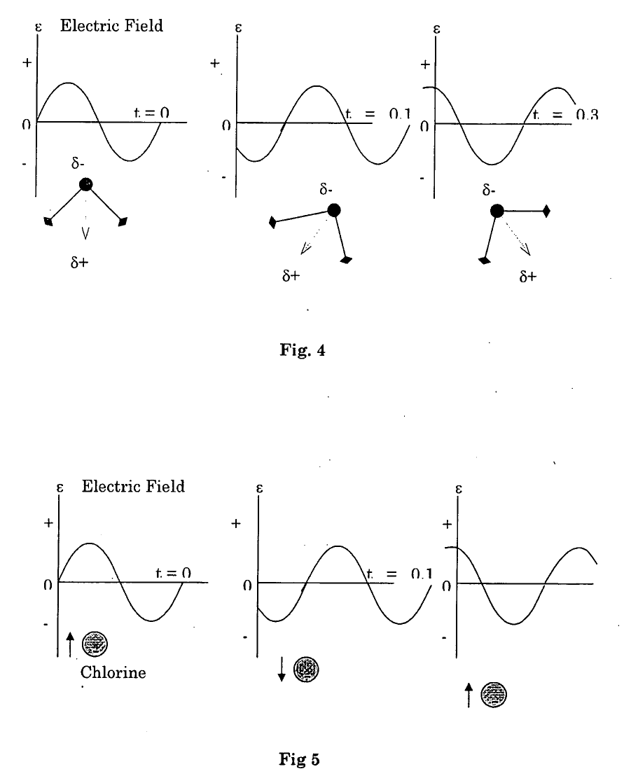

Microwave dielectric heating is dependant on the ability of a material to absorb mainly the electric component of microwave energy and generate heat. The heating is caused by two main mechanisms including dipole polarization and ionic conduction. When polar molecules interact with microwave frequencies, they align themselves and oscillate with the oscillating electric field as is illustrated by the diagrams of FIG. 4 of a water molecule aligning to the field. Energy is lost in this process through molecular friction which is substantially manifested as heat in the material. The time period of microwave radiation is in order of nanoseconds (10⁻⁹sec). Thus in a coupled system, an almost constant energy input is achieved at a rate far greater than a molecular relaxation rate in liquid state, which is in the order of microseconds (10⁻⁵sec). As a result, an absorbing liquid medium may have almost instantaneous local superheating and temperatures can reach much above the liquid's boiling point. It should be noted that gas molecules cannot be heated by microwave radiation since distance between rotating dipoles are too high to create molecular friction. Ionic conduction, on the other hand involves oscillation of dissolved charged particles in a liquid and creating heating effect by molecular collision. FIG. 5 provides diagrams of to illustrate the ionic conduction effect on a chlorine ion where the negatively charged ion is attracted to the positive portion of a microwave and repelled by the negative section of the microwave, thus resulting in oscillation of the ion through the media. The ionic conductivity effect has a much stronger heating effect than the dipole rotation mechanism. The heating characteristic of a material are dependant on its dielectric properties expressed by its loss tangent (tanδ)

tanδ=ε″/ε′ (6)

where, ε″ is the dielectric loss indicating the efficiency with which electromagnetic radiation is converted into heat and ε′ is the dielectric constant indicating the polarizability of the molecules in the electric field. A reaction medium with a high tan6 is required for efficient absorption and rapid heating.

At 2.45 GHz, 2-butanol has a tan δ of about 0.447 and heats more rapidly than water with water having a tan δ of about 0.123. It is to be noted that the loss tangent for polystyrene is about 0.0003 and thus a negligible microwave heating effect of polystyrene matrix may be expected from microwave radiation. Table 5 lists loss tangent values for various alcohols and water. [Kappe and Stadler, 2005]

TABLE 5
Relevant properties of potential expansion agents compared to PS

| | Solubility | Boiling | Vapor pressure | |
|---|---|---|---|---|
| | Parameter | Point | at 100° C. in mm of | |
| Solvent | δt | ° C. | Hg | tanδ |
| Ethanol | 26.2 | 78.4 | 1683 | 0.941 |
| 2- | 23.5 | 82 | 1500 | 0.799 |
| propanol | | | | |
| 2-butanol | 22.2 | 99 | 806 | 0.447 |
| Water | 48.0 | 100 | 764 | 0.123 |
| PS | 18.6 | N/A | N/A | 0.0003 |

Advantageously, by using microwave as a heating source for expansion of PS, a high coupling efficiency may be achieved when heating alcohols doped with ionic salts [Metaxas & Meredith, 1983]. Zhou and Song [2005] used Calcium Chloride (CaCl₂) and Sodium Chloride (NaCl) to improve microwave coupling in their experiment to expand starch pellets into foam. It was observed that the process took about 30 sec for the pellets with the salts to foam compared with about 45-60 s for those without the salt additives.

Another advantage of using microwaves is the high frequency that may lead to fast superheating of coupled liquid much above the liquid's boiling point. This may be effective for the present invention where initially the alcohol phases are encapsulated within the polymer matrix and thus may be potentially superheated without an immediate phase change. The polymer matrix may be expected to perform like an impermeable high-pressure vessel confining the alcohol phases until heat transfer from the superheated alcohol raises the matrix temperature above glass transition. The heat transfer by conduction within a polymer of low thermal diffusivity, as well as mass transport through a glassy polymer below Tg, is typically a much slower process than superheating small volume fluid phases (in the order of micro liters) by microwave coupling. Additionally, the concentration of 2-butanol in the PS matrix and the uniformity of dispersion may substantially determine the overall heating efficiency and thus the optimization of 2-butanol distribution may be a consideration in performing the present invention in achieving maximum process efficiency. Although 2-butanol is discussed throughout the present application as a model expansion agent, the use of 2-butanol is not limiting and a variety of other alcohols including ethanol with its high loss tangent, can be used as an expansion agent even though the boiling point may be lower than the glass transition of PS.

An additional advantageous feature of the use of microwaves of the present invention is the substantially complete transparency of PS matrix towards microwaves compared to the high coupling of the expansion agent. As the PS matrix expands, the expansion agent, preferably being 2-butanol, may substantially escape out of the polymer. Since microwave heating is directly related to the mass of the 2-butanol in the PS matrix, the heat input to the system, should substantially drop at the same rate as the 2-butanol escape rate and become negligible as the contained mass of the 2-butanol expansion agent approaches zero. Fast cooling of the expanded polymer surfaces below glass transition temperature provides for an improved foaming as the newly formed cell walls are less likely to collapse. [Benning, 1969]

Furthermore, for thermal insulators, cooling occurs by the heat transfer mode of radiation and convection, both of which rely upon the present surface area. Thus convection and radiation cooling of the PS matrix is facilitated near the end of the microwave heating process with the formation of large new polymer cellular surface area due to foaming. As such, cell collapse due to slow cooling may be potentially reduced and possibly eliminated by optimizing the process of expansion.

Generally, microwaves can be guided, focused and to provide for a relatively safe and efficient work environment when compared to various prior art processes. In industry, microwave heating has been utilized in other fields both as a batch and a continuous process. Furthermore, the microwave source may be tuned to match the electrical impedance of the coupling liquid for maximizing efficiency of the subject process. Meredith emphasized the advantage of microwave heating where he stated that “[t]he overall efficiency of microwave heating systems is usually very high because of the exceptional efficiency of high-power magnetrons (85% at 900 MHz, 80% at 2450 MHz). Very fast feedback control loops can be used to control process parameters accurately, leading to improved product quality.”

Energy savings may be expected in microwave heating, as a microwave oven has an about instantaneous control of power, thus ensuring rapid startup and rapid establishment of equilibrium conditions after a change. Additionally, with new developments in microwave technology it is expected that in years to follow, microwave heating applications shall become even more efficient and easier to operate.

In order to further illustrate the principles and operation of the present invention, the following example is provided. However, this example should not be taken as limiting in any regard.

### EXAMPLE 1

Styrene monomer of high purity (about 99% or greater), containing about 10-15 ppm 4-tert-butylcatechol as inhibitor, supplied by Sigma-Aldrich is filtered through a column of Alumina powder to remove inhibitors. 2-butanol with high purity (about 99% or greater) is supplied by Fischer scientific. Azobisisobutylonitrile (AIBN) (98% purity) supplied by Sigma-Aldrich is used as the free radical initiator.

An AIBN initiator (240 mg in 20 ml styrene) is dissolved in styrene by ultrasonication for about 15 minutes. The monomer with initiator is then dispensed in about 2 ml capacity airtight vials using micropipette. A batch of 5 solution samples is prepared with varying concentrations of 2-butanol in the monomer/initiator system using ultrasonication for about 15 minutes. Sample concentrations are indicated in Table 6.

TABLE 6
Sample ID and 2-Butanol concentration

| | Sample # | | | | |
|---|---|---|---|---|---|
| | 1 | 2 | 3 | 4 | 5 |
| 2-butanol | 4 | 6 | 7 | 8 | 9 |
| volume % | | | | | |

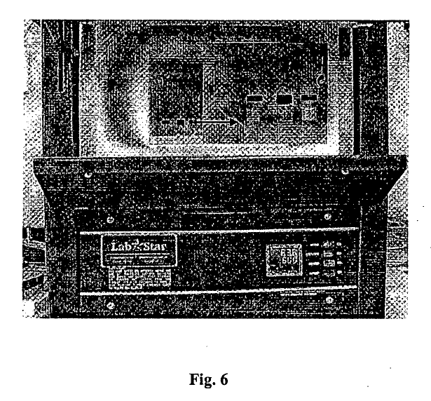

Generally, laboratory scale bulk polymerization is performed in a closed flask with condensers attached and continuous stirring and heating on a hot plate. Mechanical stirring may be used to maintain a thermal equilibrium throughout the monomer bulk and to provide a homogeneous distribution of growing chains. However, for explaining the present invention, the purpose of this polymerization is to obtain cast polymer pellets in the cylindrical shape of the 2 ml reaction vial. Alternatively, to achieve thermal equilibrium in the reaction vials without mechanical stirring, the vials may be heated by radiation in a precision furnace with a PID feedback control system. The furnace, in one embodiment, as illustrated in FIG. 6, is manufactured by Vector Furnaces Ltd. The samples are heated at about 80° C. to about 100° C. and preferably at about 90° C. for about 20 to about 30 hours and preferably about 24 hours and annealed in the furnace for about 1 to about 3 hours and preferably about 2 hours at about 40° C. to about 60° C. and preferably at about 50° C. to achieve polymerization and to induced phase separation. The polystyrene may then be obtained in intact pellet form by breaking the sample vial by a sharp impact.

Bulk polymerization of styrene and 2-butanol may be carried out to obtain pellets of substantially larger size than commercially used beads. Generally, the commercial process involves convection heating by steam. Convection heat transfer is a surface dependant process and thus a high surface to volume ratio is required. As the novel method of the present invention uses electromagnetic radiation, which is a volumetric process, larger individual volumes (pellets) are acceptable though the process is not limited to such. Additionally, the samples may be annealed and subjected to Scanning electron microscopy (SEM) and Thermo Gravimetric Analysis (TGA) to verify the uniformity of phase distribution throughout the matrix.

Furthermore, to study the effect of microwave heating by ionic conduction, special samples are prepared using organic salt lithium perchlorate. Four percent to about 16 percent by volume, and preferably about 9 percent by volume of 2-butanol is selected for the concentration of the expansion agent. Four samples are prepared, two containing 0.1% by weight of lithium perchlorate dissolved in 2-butanol with the other two comprising regular 2-butanol phase in polystyrene matrix.

Gel permeation chromatography is used to determine the number average molar mass (Mn), the weight average molar mass (Mw), and the molar mass distribution (Mw/Mn) of the PS. The samples are measured on a Waters Modular GPC though may be measured with other equipment. Preferably, the temperature of column and detector is maintained at about 30° C. to about 50° C., and more preferably at about 40° C. A solvent such as THF may be used at about 1 ml/minute with an injection volume of about 50 ml and a sample concentration of about 2 mg/ml. The columns may be calibrated with polystyrene standards such as Toyo Soda polystyrene standards.

Verification of the 2-butanol content of the pellets is determined by measuring the weight loss of PS samples containing different concentration of 2-butanol by using TGA under Nitrogen flow of about 100 ml/min. The temperature sequence started at about 30° C. at a heating rate of 5K/min to 180° C. and is followed by an isotherm at about 180° C. for 20 min. The instrument used is a TA instrument with model name TGA Q50 V6.7 Build 203.

The glass transition temperature (Tg) of PS samples and approximate temperature range of expansion is determined using a Mettler DSC 821. The heating rate is of from about 2° C./min to about 8° C./min and preferably at about 5° C./min for each sample with two heating runs from 30° C. to 180° C. to be conducted with about 100 ml/min N₂ as the purge gas. An isotherm of from about 20° C. to about 40° C. and preferably at about 30° C. is run for 15 minutes to obtain thermal equilibrium within the sample. Indium may be used for temperature and heat of fusion calibration.

For verification purpose a modulated test is also performed. The operating parameters are approximately
Isotherm at 25° C. for 10min
Temperature ramp from 25° C. to 75° C. at 5° C./min
Isotherm at 75° C. for 5 min
Temperature drop from 75° C. to 25° C. at −5° C./min
Isotherm at 25° C. for 5 min
Temperature ramp from 25° C. to 75° C. at 5° C./min
   with each test being conducted two times to check for repeatability.

SEM is performed on all samples to visualize the 2-butanol phase separation droplet size and dispersion. The high vacuum inside the SEM chamber creates evaporation of the 2-Butanol liquid phases and exposes the separated phases as holes on the surface. Fractured surfaces of PS pellets are imaged after coating with gold. A LEO 1525 Field Emission scanning electron microscope is used.

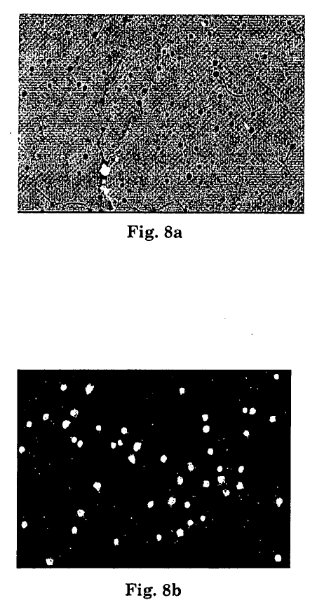

Two image processing programs are used for analysis for the SEM images. ImageJ image processing program is used to establish binary contrast, as seen in FIG. 8, between the 2-butanol phases from the matrix by threshold function. ImagePro Plus 4.5.0.19 is used to determine the mean diameter, standard deviation, and size distribution of the holes.

Styrene samples with varying concentrations of 2-butanol (Table 7) and calculated amount of free radical initiator are prepared in a batch of airtight vials of 2 ml capacity. The vials are heated in the programmable precision furnace at about 90° C. for 24 hours. After completion of polymerization the furnace temperature is allowed to drop by 1 degree and maintain steady state for 1 hour. The vials at about 89° C. are visually checked for signs of turbidity (cloud point). At cloud point, a sharp alteration of light transmission occurs due to scattering of light at separated phases and the entire sample turns opaque/translucent. This process is repeated at intervals of about 1° C. until a temperature of from about 24° C. to about 30° C. is reached, with about 27° C. being preferable, and subsequent cloud points are plotted as concentration versus temperature to obtain a phase diagram at a specific molecular weight. The molecular weight and distribution of the samples are determined by GPC.

TABLE 7
Sample ID with concentration of expansion agent for determination
of phase diagram experiment.

| | Sample # | | | | | | | | | | |
|---|---|---|---|---|---|---|---|---|---|---|---|
| | 1 | 2 | 3 | 4 | 5 | 6 | 7 | 8 | 9 | 10 | 11 |
| 2-butanol | 4 | 6 | 8 | 10 | 12 | 14 | 16 | 18 | 20 | 22 | 24 |
| % volume | | | | | | | | | | | |

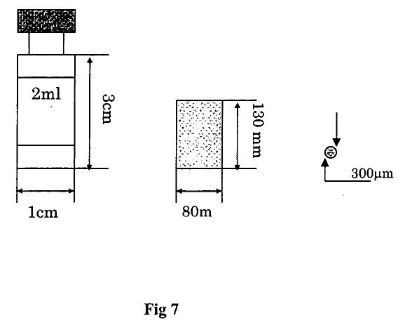

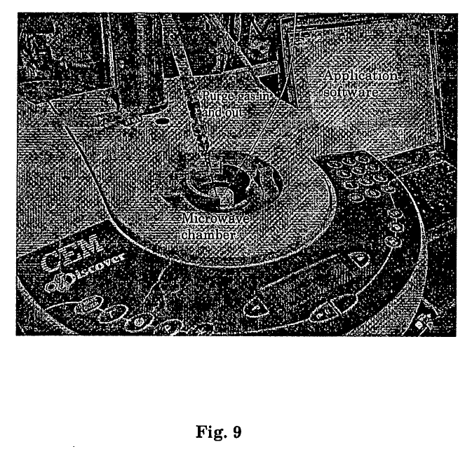

Laboratory scale microwave oven (illustrated in FIG. 9) are used to expand polystyrene pellets of different 2-butanol concentration as provided in FIG. 7. The oven may be model CEM Discover with the microwave unit operating at 2.45 GHz and producing continuous waves at maximum power of 300 W. The oven may include a cylindrical chamber designed to fit one factory standard test tube as reaction chamber. The test tubes are supplied with a special cap that acts as a safety pressure seal. In case of evolution of gasses from the reactor, a purge gas system may be used by inserting inlet and outlet needles through a safety cap of the vial. The purged gas is then passed through a room temperature trap with silicone oil. The temperature inside the chamber is measured and controlled by an infrared temperature measuring feedback system. A PID system controls the microwave power supplied to the reactor by reading the temperature feedback. Factory supplied application software may be used to control and measure the transient temperature and power profile. After trial and error experiments the preferable experimental conditions for expansion of polystyrene pellets may be determined. By no means are such conditions limiting, and are only taken to represent one possible set of conditions for the novel process. As such, the conditions may be as the following:
Temperature Ramp Time: 10 seconds
Temperature Hold Time: 60 seconds
Maximum Power: 300 W
Purge Gas: Argon

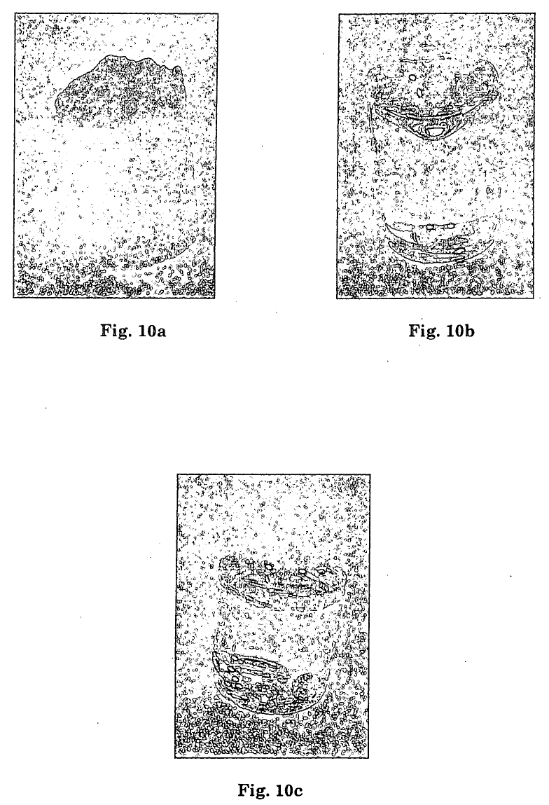

Polymerized samples (FIGS. 10a, 10b and 10c) are obtained with varying concentrations of 2-butanol in polystyrene matrix as cylindrical pellets. At room temperature a critical volumetric concentration of 8% 2-butanol is identified as the cloud point for the samples obtained as illustrated in FIG. 10a, where FIG. 10b had a concentration of 7% 2-butanol and FIG. 10c had a concentration of 6%.

Gas phase chromatography (GPC) results for three samples with varying 2-butanol concentration along with commercial expandable polystyrene bead (T170B) supplied by Styrochem, is tabulated below in Table 8.

TABLE 8
GPC results for polystyrene samples

| Sample # | Mw | Mn | PDI |
|---|---|---|---|
| T170B | 260,300 | 120,200 | 2.16 |
| 8% | 204,700 | 92,180 | 2.221 |
| 7% | 198,500 | 103,600 | 1.972 |
| 6% | 263,700 | 122,200 | 2.158 |
| Mean | 222,300 | | 2.117 |
| (Excluding | | 105,993 | |
| T170B) | | | |

Although all samples may be prepared from the same initiator concentration, the volumes of the samples may be slightly different in order to obtain accurate volumetric concentrations of 2-butanol. Also, an oxygen free environment to reduce free radical scavenging was not provided for polymerization. Although, a very close molecular weight and distribution is obtained as compared to commercial samples, the deviation among the individual samples may be attributed to the above-mentioned causes.

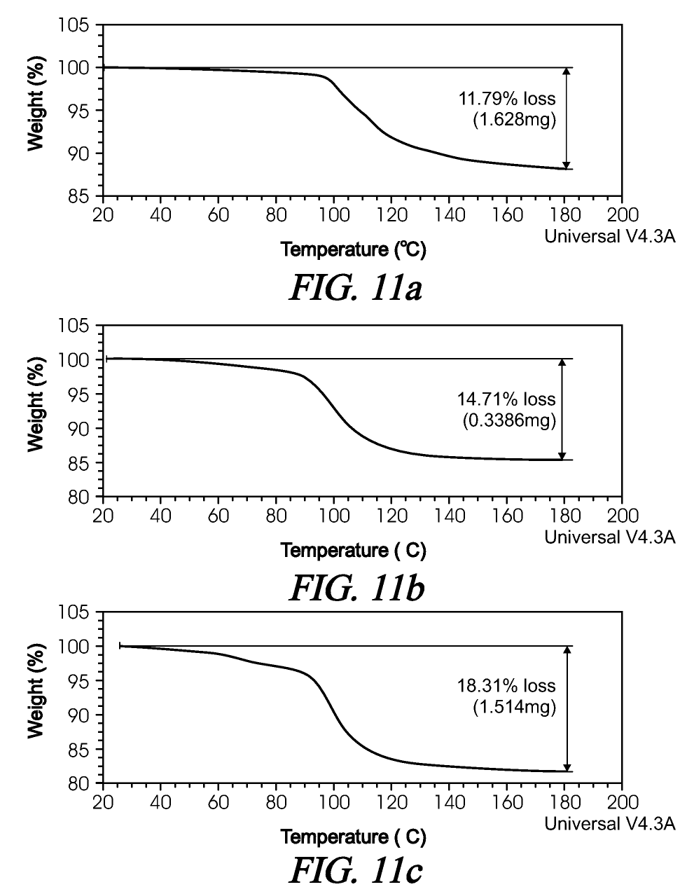

Thermogravimetric Analysis (TGA) results are used to check the weight percentage of 2-butanol samples. The results are illustrated below in Table 9 and FIG. 11a-c showing three sample TGA graphs, with FIG. 11a for Sample #5, FIG. 11b for Sample #6 and FIG. 11c for Sample #7.

TABLE 9
TGA report of 2-Butanol weight percentage

| | Volumetric % | Weight % |
|---|---|---|
| Sample # | composition | Composition |
| 1 | 0 | 0 |
| 2 | 6 | 5.2 |
| 3 | 8 | 7.8 |
| 4 | 10 | 9.1 |
| 5 | 12 | 11.79 |
| 6 | 16 | 14.71 |
| 7 | 18 | 18.31 |

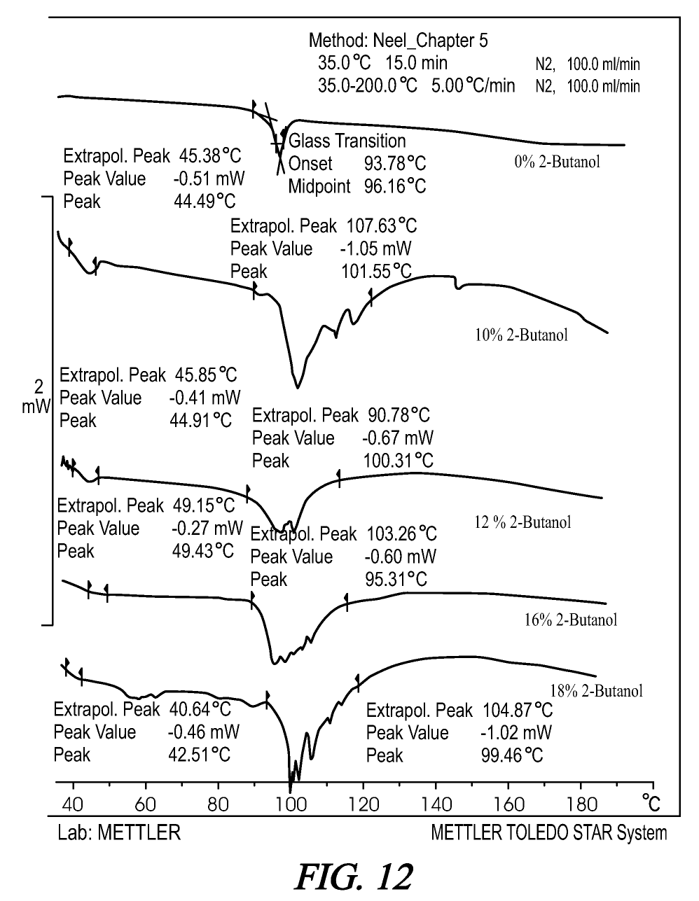

Differential Scanning Calorimeter (DSC) results for 0%, 10%, 12%, 16% and 18% concentrations of 2-butanol+PS are presented in FIG. 12.

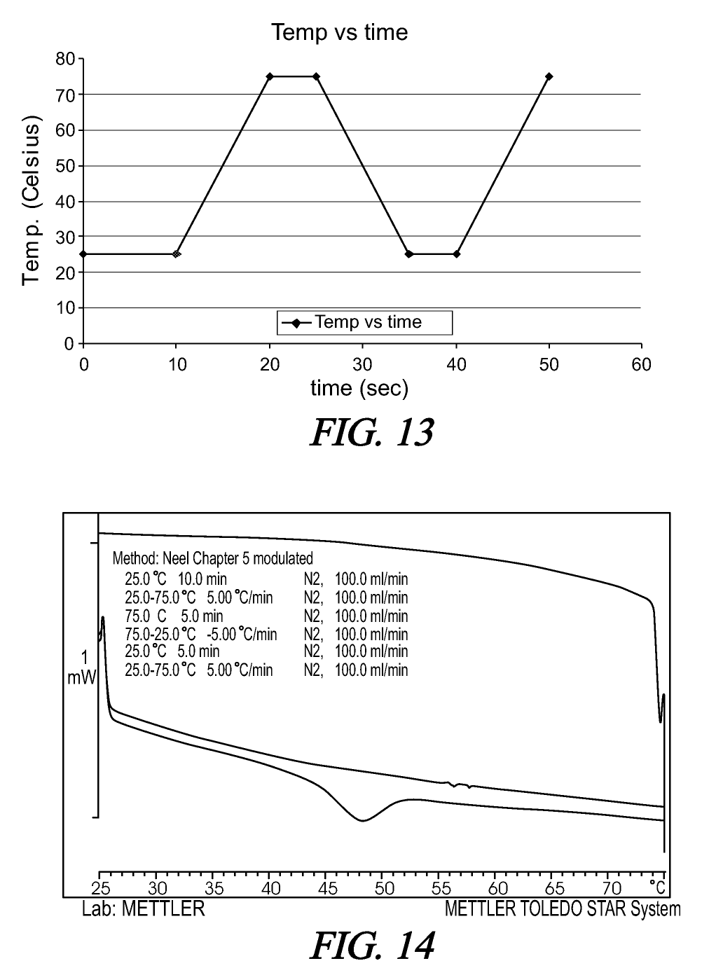

For the pure PS sample the glass transition is obtained at about 96.16° C., which is generally within the acceptable range of glass transition for polystyrene. However for the other samples containing 2-butanol the Tg coincides about with the boiling point of 2-butanol (99° C.) and is more difficult to separately distinguish as a DSC peak is likely encountered due to the evaporation of 2-butanol phase. The DSC data correlates well with the TGA data and both illustrate the temperature range for liberation of the 2-butanol to be between about 90° C. to about 120° C. The TGA data also illustrates mass loss due to evaporation between the temperatures of from about 55° C. to about 90° C. increasing with an increase in concentration of 2-butanol. Furthermore, this also correlates with the DSC data, particularly with the 18% sample showing signs of gas evolution through constant fluctuation of the baseline between from about 55° C. to about 90° C. For each polymer sample containing 2-butanol phase, a change in specific heat capacity is noted with peak in the range of from about 44° C. to about 49° C. The endothermic and exothermic changes may be collectively attributed to latent heat of evaporation of 2-butanol from the surface and diffusion through porous media and mass loss, because the experiments were run using open type pans. The irreversible nature of this curve may be verified by modulating the temperature in the ranges of from about 25° C. to about 75° C. with as illustrated in FIG. 13. The resulting DSC results as illustrated in FIG. 14 may illustrate that the initial peak observed at approximately 48° C. is likely not a relaxation peak as it is irreversible. Thus it may be attributed to evaporative mass loss, which also correlates with the TGA results.

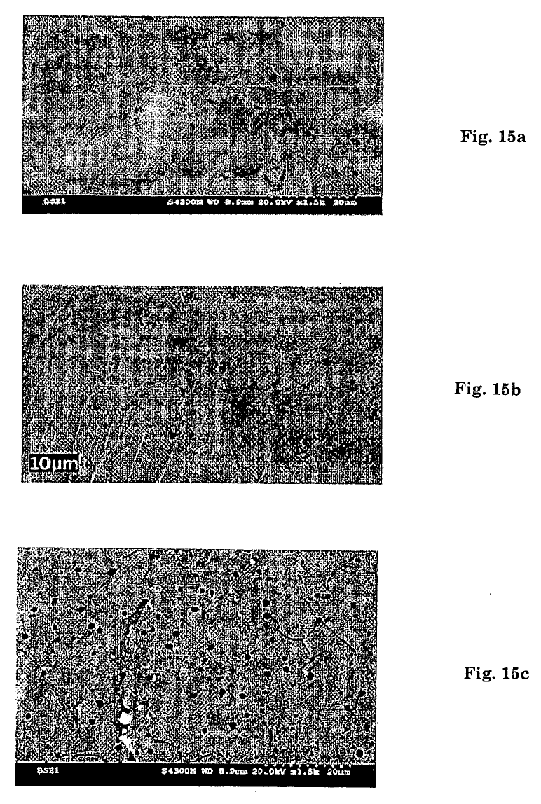

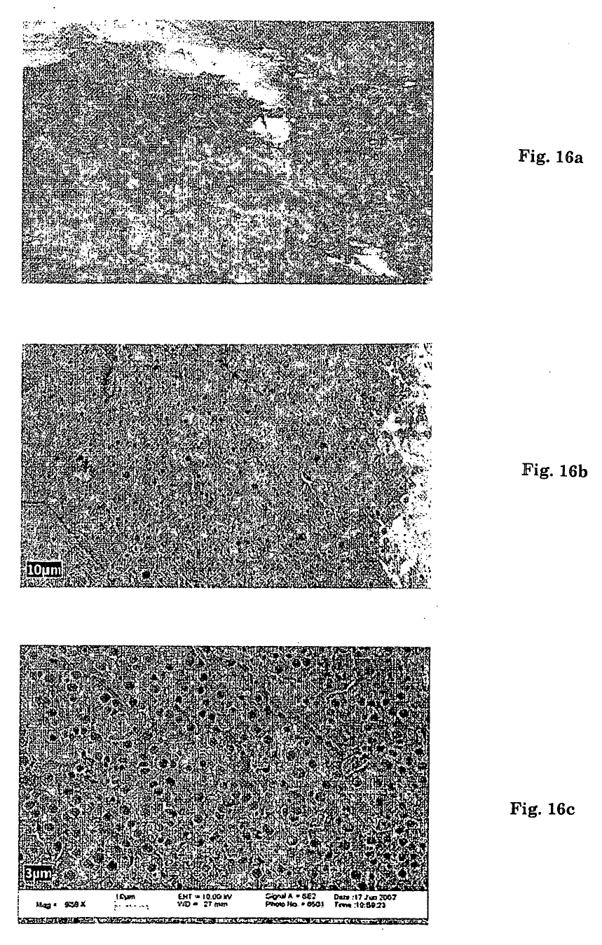

SEM images help provide evidence of nucleation and growth of the 2-butanol phases in PS matrix as polymerization of styrene-2-butanol system progressed as illustrated in FIGS. 15a-c and FIGS. 16a-c. The phase separation achieved through the novel method produced morphology with distributed spherical alcohol phase (droplets) within the polymer matrix, with the morphological characterizations provided in Table 10.

TABLE 10
Morphological characterizations of 2-Butanol phases in PS
matrix at room temperature

| | | Mean | | |
|---|---|---|---|---|
| | 2- | Dia. | SD | |
| # | Butanol % | μm | μm | Comments |
| 1 | 6 | 0 | 0 | 2-butanol does not appear to show any phase separ- |
| | | | | ation and remains in solution in the PS matrix. |
| 2 | 8 | 2.3 | 0.2 | Phase separated spherical domains appear to be ob- |
| | | | | served at 8% by volume concentration of 2-butanol |
| 3 | 10 | 1.6 | 0.2 | Phase separated domain dimensions and distribution |
| | | | | increase appear to be observed at 10% by volume |
| | | | | concentration of 2-butanol |
| 4* | 12 | N/A | N/A | At 12% by volume concentration the phase dimensions |
| | | | | and distribution increase further |
| 5 | 14 | 1.3 | 0.4 | bimodal distribution of phase dimensions is observed |
| 6 | 16 | 3.3 | 0.3 | The phase dimensions and distribution increase further |
| | | | | and seem to saturate the matrix. The diameter becomes |
| | | | | larger than the separation distance between 2 |
| | | | | spherical 2-butanol phases. |

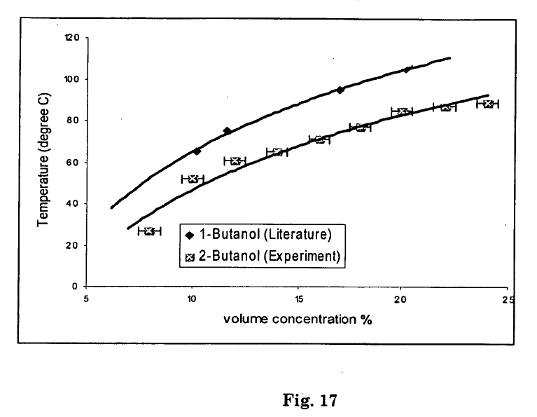

The cloud points are plotted as illustrated in FIG. 17 to provide for the phase diagram for 2-butanol in PS matrix. As the experiment may be performed with equipment having a temperature resolution of 1° C., an error bar of ±1° C. is used in FIG. 17. From TGA data, the concentrations are verified to be fairly accurate and thus a ±0.5% concentration error bar is used in the abscissa to help illustrate the results. Literature values obtained for solubility of 1-Butanol in Polystyrene are included in FIG. 17 for comparison [Bernardo, 2007]. The PS used in the literature had Mn=140,000 with PD=1.64 while the PS of this example has about a mean Mn=105,993 with a mean PD=2.117. The lower solubility in the literature case of 1-butanol may be attributed to its longer chain length and higher molecular weight of the matrix.

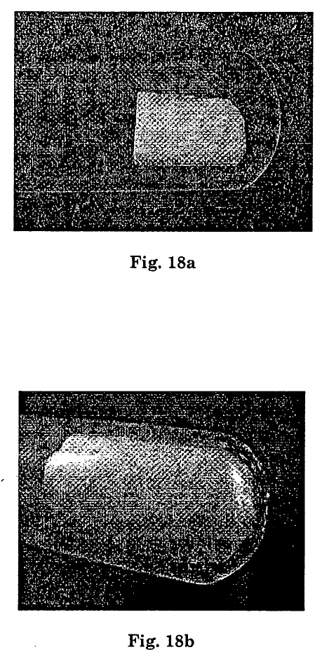

Generally the novel method of the present invention provides for the synthesis of polystyrene pellets with varying concentration of alcohol, and preferably 2-butanol, by bulk polymerization and PIPS technique. About 5% to about 15%, and preferably about 8% by weight of alcohol is found to be a concentration wherein phase separation will occur. Characterized microwave radiation may then be used to expand solid polymer pellets (as illustrated in FIG. 18a) into expanded polystyrene inside glass test tube molds as shown in FIG. 18b.

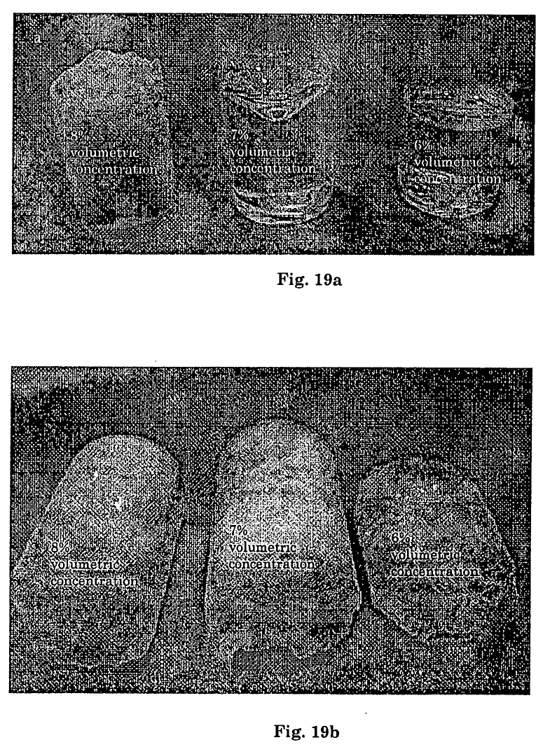

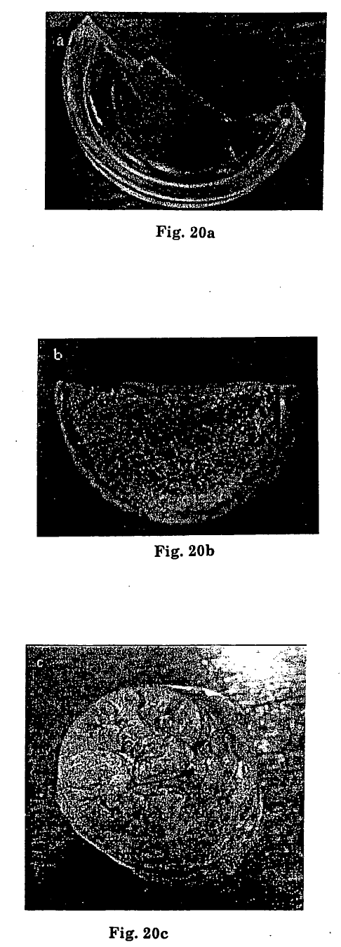

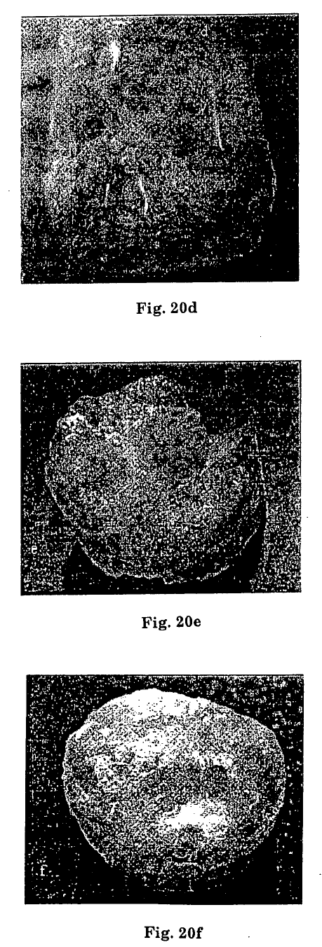

The novel process using microwave expansion of PS pellets containing 2-butanol, may provide for uniform foam formation which may be observed for those samples with phase separation. Generally, differing percentages provided for differing characteristics of the final foam product produced through the novel process. The 4% sample can provide material with void spaces formed inside the sample due to the phase change of 2-butanol. The 6% sample may expand with a high density. The 8% sample can have a substantially open cellular structure throughout the expanded sample with samples provided in FIGS. 19a-b and FIG. 20a-f.

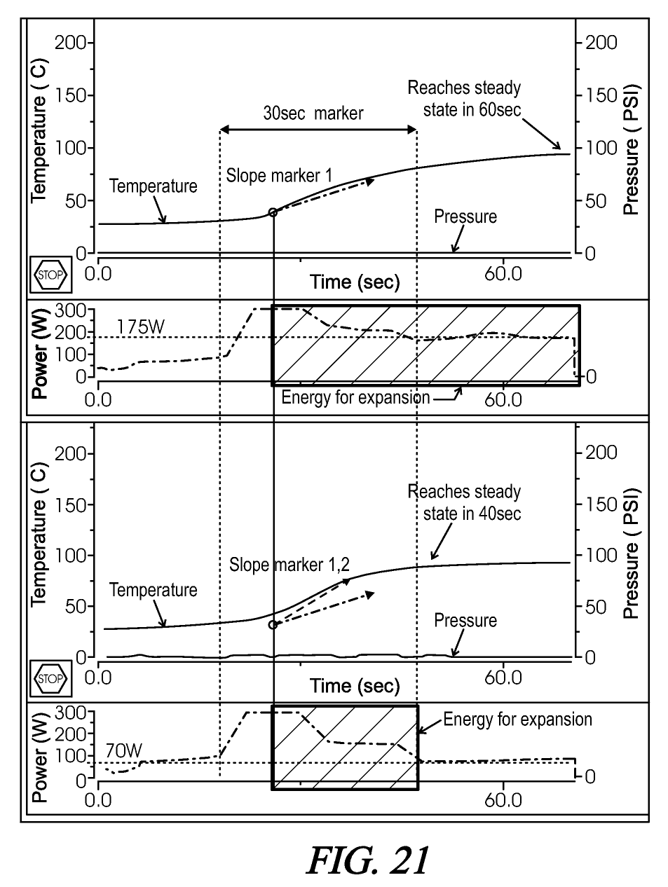

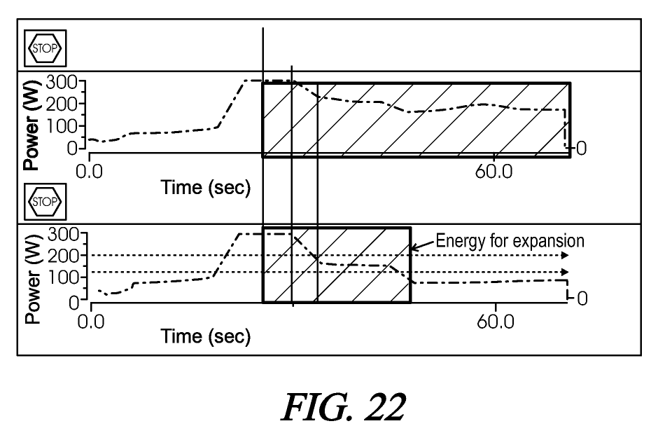

Using ionic conduction with 0.1% weight fraction of lithium perchlorate (w.r.t 2-butanol), a significant increase in microwave coupling efficiency may be observed. In order to reach the target temperature of from about 85° C. to about 100° C., and preferably about 93° C. a much lower average power of 80 W may be required compared to average power of 175 W in case of heating by dipole rotation. The preferable target temperature of about 93° C. is reached and steady state obtained after 20 seconds to about 50 seconds, and preferably about 40 seconds, of hold time compared to 60 seconds required for the case of heating by dipole rotation alone as illustrated in FIG. 21. The area under the power-time curve is calculated to be approximately 9,000 Joules in case of heating by dipole rotation while the energy required is reduced to approximately 4,575 Joules in case where salt is added as illustrated in FIG. 22.

Additionally, the novel process of using microwaves with alcohol for creating a foam product provides for a greater flexibility in molding the final foam product. Stainless steel molds, which are prevalent in the prior art are not utilized in the process of the present invention as microwaves can be utilized with glass molds. By using glass molds, the costs in forming stainless steel molds are substantially eliminated from the present invention. Furthermore, besides glass, appropriate microwave transparent plastic molds can be synthesized and utilized in the process of the present invention which would also substantially eliminate the need for stainless steel molds and tooling as is currently used in much of the prior art. Yet furthermore, the whole process of pre-expansion may be eliminated if expandable beads can be maneuvered freely inside the microwave transparent mold, while being expanded as can be accomplished by the present invention.

The disclosures of all cited patents and publications referred to in this application are incorporated herein by reference.

The above description is intended to enable the person skilled in the art to practice the invention. It is not intended to detail all of the possible variations and modifications that will become apparent to the skilled worker upon reading the description. It is intended, however, that all such modifications and variations be included within the scope of the invention that is defined by the following claims. The claims are intended to cover the indicated elements and steps in any arrangement or sequence that is effective to meet the objectives intended for the invention, unless the context specifically indicates the contrary.

What is claimed is:

1. A method for producing an expanded material comprising the steps of:
a) providing a substrate;
b) adding an alcohol expansion agent to the substrate to form a substrate and alcohol combination; and
c) subjecting the substrate and alcohol combination to microwaves to at least partially create an expanded product from the substrate and alcohol combination.

2. The method of claim 1 wherein the alcohol expansion agent comprises ethanol.

3. The method of claim 1 wherein the alcohol expansion agent comprises propanol.

4. The method of claim 1 wherein the alcohol expansion agent comprises butanol.

5. The method of claim 1 wherein the substrate comprises polystyrene.

6. The method of claim 1 wherein the substrate comprise styrene.

7. The method of claim 1 wherein alcohol expansion agent is added in step b) to create a substrate and alcohol combination having of from about 5% to about 18% by weight of the alcohol expansion agent.

8. The method of claim 7 wherein the alcohol expansion agent is added in step b) to create a substrate and alcohol combination having of from about 6% to about 12% by weight of the alcohol expansion agent.

9. The method of claim 1 wherein step b) further comprises adding the alcohol expansion agent to the substrate and subsequently polymerizing the substrate to form a polymer matrix which at least partially encapsulates the alcohol expansion agent.

10. The method of claim 9 wherein the alcohol expansion agent and the substrate are heated at about 80° C. to about 100° C. for about 20 hours to about 30 hours.

11. The method of claim 10 further comprising annealing the alcohol expansion agent and the substrate at about 40° C. to about 60° C. for about one 1 hour to about 3 hours after the heating at about 80° C. to about 100° C. for about 20 hours to about 30 hours.

12. The method of claim 1 where step b) further comprises adding an ionic salt with the alcohol expansion agent.

13. The method of claim 12 wherein the ionic salt comprises lithium perchlorate.

14. The method of claim 12 wherein the ionic salt comprises calcium chloride.

15. The method of claim 12 wherein the ionic salt comprises sodium chloride.

16. A method of producing an expanded polymeric material comprising the steps of:
a) providing a polymer substrate;
b) applying an alcohol expansion agent to the polymer substrate to form a polymer substrate and alcohol combination;
c) polymerizing the polymer substrate and alcohol expansion agent to form a polymer matrix at least partially containing the alcohol expansion agent; and
d) heating the polymer matrix with alcohol expansion agent with microwaves to create a foam product from the substrate and alcohol combination.

17. The method of claim 16 wherein step d) further comprises heating the polymer matrix with expansion agent within a non-metallic mold to create an at least partially molded foam product.

18. A method of producing an expanded polymeric material comprising the steps of:
a) providing styrene;
b) combining butanol with the styrene to create an of from about 5% to about 18% by weight butanol mixture of butanol and styrene;
c) heating the mixture of butanol and styrene at about 80° C. to about 100° C. for about 20 hours to about 30 hours to form a heated butanol and styrene mixture;
d) annealing the heated butanol and styrene mixture at about 40° C. to about 60° C. for about one 1 hour to about 3 hours to form a polystyrene matrix at least partially encapsulating butanol; and
e) contacting the polystyrene matrix with butanol with microwaves to create an expanded polymeric material.

19. The method of claim 18 wherein step b) further comprises adding an ionic salt to the butanol and styrene.

20. The method of claim 18 wherein step e) further comprises creating the expanded polymeric material within a nonmetallic mold.
